(19) United States
(12) Patent Application Publication
(10) Pub. No.: US 2020/0364047 A1
(43) Pub. Date: Nov. 19, 2020

(54) HIGH THROUGHPUT NEURAL NETWORK OPERATIONS USING INTER-LAYER MEMORY LAYOUT TRANSFORMATION

(71) Applicant: Facebook, Inc., Menlo Park, CA (US)

(72) Inventors: Ehsan Khish Ardestani Zadeh, San Jose, CA (US); Krishnakumar Nair, Newark, CA (US); Abdulkadir Utku Diril, Menlo Park, CA (US); Dheevatsa Mudigere, Fremont, CA (US); Olivia Wu, Los Altos, CA (US); Yuchen Hao, Fremont, CA (US)

(21) Appl. No.: 16/414,534

(22) Filed: May 16, 2019

(51) Int. Cl. G06F 9/30; G06N 3/08; G06F 9/38; G06F 9/54; G06N 3/04

(52) U.S. Cl. CPC G06F 9/30036; G06N 3/08; G06N 3/0454; G06F 9/544; G06F 9/3869

(57) ABSTRACT

A microprocessor comprises a shared memory and a processing element. The processing element includes a matrix processor unit, a transpose hardware unit, a scatter hardware unit, and a gather hardware unit. The matrix processor unit is configured to perform a matrix operation. The transpose hardware unit is configured to perform a matrix transpose operation. The scatter hardware unit is configured to place data to the shared memory at locations selected for an output data layout conversion. The gather hardware unit is configured to obtain input data from the shared memory from non-contiguous locations for an input data layout conversion.

### BACKGROUND OF THE INVENTION

Neural networks typically operate on large data sets and can consume significant computational and memory resources to solve complex artificial intelligence problems. The creation of customized microprocessors improves the computational efficiency of neural networks in part by optimizing the matrix operations performed on the input data. These customized microprocessors are typically designed to optimize a single type of convolution. However, different types of neural networks may require different types of matrix operations including different types of convolution operations. Moreover, as neural networks become more complex and/or specialized, different layers of a neural network may require different types of matrix operations. Therefore, there is a need for a microprocessor system that supports multiple types of convolution operations while maintaining high computational throughput when performing neural network operations.

### BRIEF DESCRIPTION OF THE DRAWINGS

Various embodiments of the invention are disclosed in the following detailed description and the accompanying drawings.

FIG. 1 is a block diagram illustrating an embodiment of a system for solving artificial intelligence problems using a neural network.

FIG. 2 is a block diagram illustrating an embodiment of a processing element for solving artificial intelligence problems using a neural network.

FIG. 3 is a flow chart illustrating an embodiment of a process for solving artificial intelligence problems using a neural network.

FIG. 4 is a flow chart illustrating an embodiment of a process for solving artificial intelligence problems using a multi-layer neural network.

FIG. 5 is a flow chart illustrating an embodiment of a process for solving artificial intelligence problems using a multi-layer neural network.

FIG. 6 is a flow chart illustrating an embodiment of a process for solving artificial intelligence problems using a multi-layer neural network.

FIG. 7 is a flow chart illustrating an embodiment of a process for solving artificial intelligence problems using a multi-layer neural network.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A microprocessor system and related techniques to support high throughput neural network operations are disclosed. In various embodiments, a microprocessor system utilizes inter-layer memory layout transformations to support sustained peak throughput neural network operations, for example, when applying a multi-layer neural network to solve complex artificial intelligence problems. The disclosed techniques allow a neural network with multiple layers that alternate between different types of matrix operations to operate efficiently. For example, the output of a layer that performs a two- or three-dimensional convolution can feed into a layer that performs a depthwise convolution with minimal impact on computational efficiency. Similarly, the output of a layer that performs a depthwise convolution can feed into a layer that performs a two- or three-dimensional convolution with minimal impact on computational efficiency. In various embodiments, the different layers of a neural network can alternate between different types of matrix operations to support a variety of neural network configurations. The disclosed microprocessor system contains hardware units including a processing element with access to shared memory. In various embodiments, the processing element includes a matrix processor unit for performing matrix operations, a transpose hardware unit for performing matrix transpose operations, a scatter hardware unit, and a gather hardware unit. The scatter and gather hardware units allow data to be written and read from shared memory based on data layout formats. The scatter hardware unit can place data to shared memory at non-contiguous locations and the gather hardware unit can obtain data from shared memory from non-contiguous locations. The hardware units may be utilized in overlapping configurations to operate in parallel such as in a pipelined architecture. In various embodiments, the writing and reading of data from shared memory using efficient data layout formats allows the matrix processor unit to operate at peak throughputs with minimal stalling. In some embodiments, the various hardware units of the microprocessor system and the configurable memory layout formats allow the microprocessor system to significantly increase the computational throughput when solving artificial intelligence problems. In some embodiments, the disclosed techniques are used to efficiently address mismatched layout formats between neural network layers. For example, a neural network layer that requires data in a height×weight×channel (HWC) format can precede a layer that requires the data in a channel×height×weight (CHW) format, and vice versa.

In some embodiments, a microprocessor comprises a processing element and shared memory in communication with the processing element. For example, one or more microprocessors each with at least a processing element are able to read and/or write from a shared on-chip memory component. In some embodiments, the processing element includes a matrix processor unit, a transpose hardware unit, a scatter hardware unit, and a gather hardware unit. In various embodiments, each of the units may be a separate hardware unit. The matrix processor unit is configured to perform a matrix operation. For example, the matrix processor unit can perform matrix operations including dot product operations. The transpose hardware unit is configured to perform a matrix transpose operation. For example, an input matrix can be transposed using the transpose hardware unit. The scatter hardware unit is configured to place data to the shared memory at locations selected for an output data layout conversion. For example, the scatter hardware unit can scatter the channels of matrix data such that all the data belonging to a channel will be contiguous according to a particular output data layout format. In various embodiments, the scatter hardware unit can scatter data to non-contiguous locations of the shared memory according to a layout format. The gather hardware unit is configured to obtain input data from the shared memory from non-contiguous locations for an input data layout conversion. For example, the gather hardware unit can gather data from shared memory by reading data corresponding to each channel using a stride read so that the processing element has different channels in different consecutive lines.

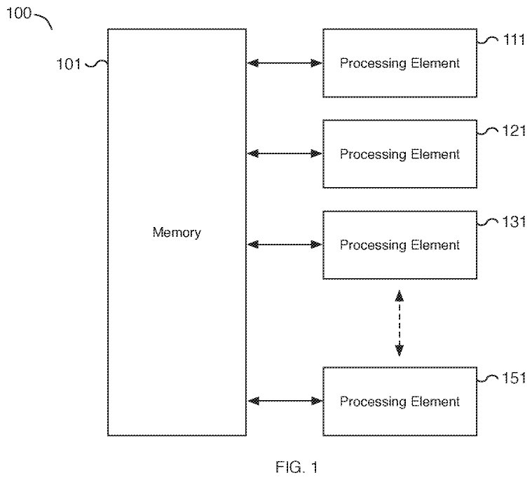

FIG. 1 is a block diagram illustrating an embodiment of a system for solving artificial intelligence problems using a neural network. In the example shown, system 100 includes memory 101 and processing elements 111, 121, 131, and 151. In some embodiments, memory 101 is a shared on-chip memory component that can be accessed by one or more processing elements such as processing elements 111, 121, 131, and 151. For example, processing element 111 can read and write data to on-chip memory corresponding to computations performed on a subset of a large data matrix. Processing element 121 can read and write data to on-chip memory corresponding to computations performed on a different subset of the same large data matrix. In this manner, different portions of a complex artificial intelligence problem can be solved by spreading the computational load across different processing elements. Processing elements 111, 121, 131, and 151 can each operate in parallel to solve a portion of a larger artificial intelligence problem. In various embodiments, the system 100 of FIG. 1 may include fewer or more processing elements. For example, the number of processing elements can be scaled up or down, for example, depending on the intended computational requirements. In some embodiments, memory 101 is a last level cache (LLC) and/or may be implemented using static random-access memory (SRAM).

In some embodiments, the processing elements are used to solve layers of a neural network. For example, a processing element, such as one of processing elements 111, 121, 131, and/or 151, may be used to perform matrix operations such as convolution operations for applying a neural network to an input data set retrieved from memory 101. One or more different filters, kernels, convolution matrices, etc. may be applied to input data. The convolution operations may alternate between different types of convolutions. For example, convolution operations may include depthwise, groupwise, normal, regular, pointwise, and/or three-dimensional convolutions, among others. The resulting output of one layer may be fed to another layer and may be stored in memory 101. In various embodiments, as processing for each layer is completed, the result is stored using a data layout format that allows for efficient processing of the next layer. For example, the resulting data may be transformed and scattered to non-contiguous locations of memory 101 and subsequently read from memory 101 using a gather operation to retrieve data from non-contiguous locations of memory 101. In various embodiments, the final output of the neural network may be written to memory 101.

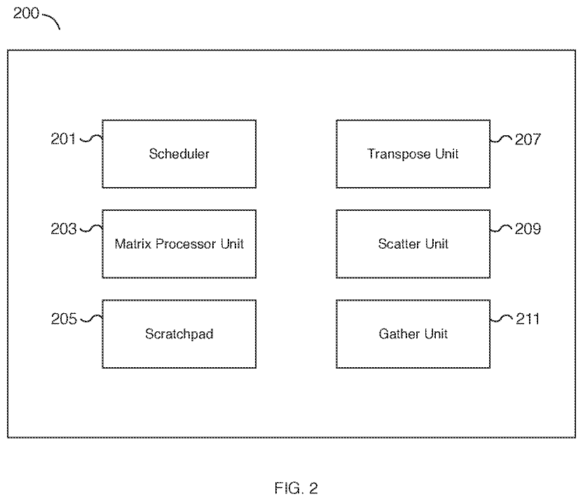

FIG. 2 is a block diagram illustrating an embodiment of a processing element for solving artificial intelligence problems using a neural network. In the example shown, processing element 200 includes scheduler 201, matrix processor unit 203, scratchpad 205, transpose unit 207, scatter unit 209, and gather unit 211. In various embodiments, processing element 200 is processing elements 111, 121, 131, and/or 151 of FIG. 1 and is communicatively connected to a memory component such as memory 101 of FIG. 1.

In some embodiments, scheduler 201 is a hardware unit for scheduling different hardware units such as matrix processor unit 203, transpose unit 207, scatter unit 209, and/or gather unit 211. Scheduler 201 may be utilized to schedule operations to be performed by the hardware units in parallel. For example, matrix processor unit 203 may perform a dot product operation while transpose unit 207 performs a matrix transform operation, scatter unit 209 performs write operations to memory, and/or gather unit 211 performs read operations from memory. In some embodiments, separate primitives exist for each hardware unit and scheduler 201 schedules the operation invoked by the different hardware primitives. For example, a transpose operation, a scatter operation, and a gather operation are primitives for invoking the respective hardware units. In various embodiments, scheduler 201 can schedule operations to be performed by the different hardware units simultaneously and/or in parallel. By overlapping computation across different hardware units, the peak throughput of processing element 200 is increased. For example, matrix processor unit 203 does not need to stall waiting for input data to be formatted into the correct layout format. Various potential bottlenecks such as converting data to and from different layout formats are minimized. In some embodiments, scheduler 201 is used to implement a pipelined architecture where one or more different hardware units can operate on different stages of neural network operations.

In some embodiments, matrix processor unit 203 is a hardware matrix processor unit for performing matrix operations including operations related to convolution operations. For example, matrix processor unit 203 may be a dot product engine for performing dot product operations. In some embodiments, the convolution operations supported include depthwise, groupwise, normal, regular, pointwise, and/or three-dimensional convolutions, among others. For example, matrix processor unit 203 may receive a first input matrix such as a subset of a large image represented as a three-dimensional matrix. The first input matrix may have the dimensions height×width×channel (HWC), channel×height×width (CHW), or another appropriate layout format. Matrix processor unit 203 may also receive a second input matrix such as a filter, kernel, or weights, etc. to apply to the first input matrix. Matrix processor unit 203 can be used to perform a convolution operation using the two input matrices to determine a resulting output matrix. In some embodiments, matrix processor unit 203 may include input and/or output buffers for loading input data matrices and writing out a result data matrix.

In some embodiments, scratchpad 205 is a memory scratchpad for storing data such as data related to neural network operations. Scratchpad 205 may be used for the temporary storage of data by different hardware units. In some embodiments, scratchpad 205 is made up of registers for fast read and write access. In various embodiments, one or more hardware units of processing element 200 can access scratchpad 205.

In some embodiments, transpose unit 207 is a hardware transpose unit for performing one or more matrix transpose operations. For example, transpose unit 207 may be a transpose engine for operating on an input matrix to transpose the matrix into a format compatible with the current or next neural network layer. In some embodiments, transpose unit 207 may be used after performing a matrix operation to prepare the matrix result data for writing to memory and/or prior to a matrix operation to prepare the matrix input data for a matrix operation. In various embodiments, transpose unit 207 can operate at the peak throughput of matrix processor unit 203.

In some embodiments, scatter unit 209 is a hardware scatter unit for writing data to memory such as a shared memory accessible by one or more different processing elements. Scatter unit 209 may be utilized to place data at locations, including non-contiguous locations, selected for performing an output data layout conversion. For example, scatter unit 209 may be utilized to write data to a shared memory where the channel dimension is the outer matrix dimension. One or more different processing elements can each perform scatter operations to write each processing element's respective data into a larger matrix according to and/or preserving a particular data layout format. In various embodiments, scatter unit 209 may perform writes along cache lines or cache line blocks. In some embodiments, scatter unit 209 can operate at the peak throughput of matrix processor unit 203.

In some embodiments, gather unit 211 is a hardware gather unit for loading data from memory such as a shared memory in preparation for performing a matrix operation. Gather unit 211 may be utilized to obtain data from a shared memory from contiguous or non-contiguous locations for an input data layout conversion. For example, gather unit 211 may be utilized to read data from a shared memory where the channel dimension is the outer matrix dimension. One or more different processing elements can each perform gather operations to read data of given channels assigned to each processing element. In various embodiments, gather unit 211 may perform reads along cache lines or cache line blocks. In some embodiments, gather unit 211 can operate at the peak throughput of matrix processor unit 203.

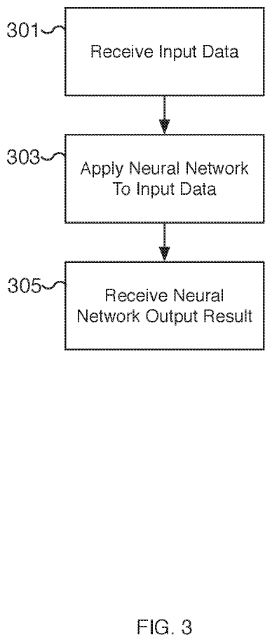

FIG. 3 is a flow chart illustrating an embodiment of a process for solving artificial intelligence problems using a neural network. For example, a multi-layer neural network is applied to input data to solve complex artificial intelligence problems such as image recognition and recommendations. In some embodiments, the neural network is applied using system 100 of FIG. 1 and/or one or more processing elements 200 of FIG. 2.

At 301, input data is received. For example, input data in the form of a matrix is received. In some embodiments, the matrix is a three-dimensional matrix with dimensions corresponding to height, width, and channels. The input data may be formatted using different data layout formats, for example, depending on how efficient it is to perform a configured matrix operation. In various embodiments, the data layout format utilizes a height×width×channel (HWC) layout, a channel×height×width (CHW) layout, or another appropriate data layout format. The input data may be located in a shared memory or another memory storage medium.

At 303, a neural network is applied to input data. For example, the input data is applied to a neural network by allocating and distributing the neural network operations across one or more different processing elements. In some embodiments, each processing element is assigned a portion of the neural network operations and may process the results of one or more layers of the neural network. In some embodiments, each neural network may access the input data received at 301 from a shared memory. For example, a subset of the input data is retrieved from shared memory and used as an input to a matrix processor unit of each processing element. In various embodiments, the results of each processing element are written to shared memory. Each processing element may only operate on a subset of the input data and the result of each processing element may be scattered to the shared memory using an output data layout format to preserve the format of the output result.

In various embodiments, the different layers of the neural network applied at 303 may utilize different types of convolution operations. For example, the convolution operations may alternate between normal or three-dimensional convolutions and groupwise or depthwise convolutions. In some embodiments, the convolution operations may have low arithmetic intensity that prevents data reuse depending on the configured convolution operation. For example, a groupwise convolution may be performed more efficiently by a matrix processor unit using a channel×height×width (CHW) data layout due to lack of reduction across channels while a normal 3D convolution may be performed more efficiently by using a height×width×channel (HWC) layout due to reduction across channels. By allowing different convolution types between layers, the input and output data layout formats between layers may be mismatched. For example, the inner dimension of a data layout format of one layer may correspond to one of the outer dimensions of a data layout format of a subsequent layer. In various embodiments, the mismatch is addressed using the techniques disclosed herein.

At 305, a neural network output result is received. For example, each processing element writes its processing results to a shared memory. Upon completion, the output result is the output result of applying the neural network to the input data. In various embodiments, the output result is received and used to solve an artificial intelligence problem.

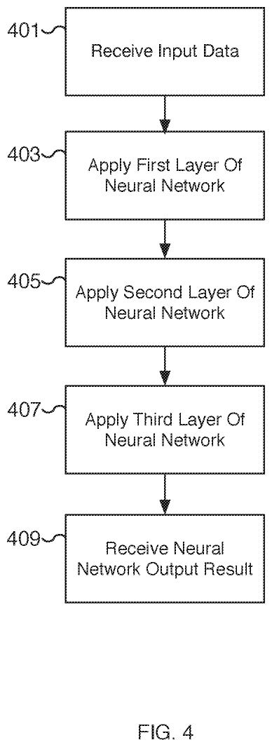

FIG. 4 is a flow chart illustrating an embodiment of a process for solving artificial intelligence problems using a multi-layer neural network. In the example shown, a neural network with three layers is applied to input data to solve complex artificial intelligence problems such as image recognition and recommendation. In some embodiments, the different layers of the neural network applied in FIG. 4 utilize different types of convolution operations. For example, the convolution operations may alternate between normal or three-dimensional convolutions and groupwise or depthwise convolutions. The input and output data layout formats between layers may be mismatched. In various embodiments, the mismatch is addressed using the techniques disclosed herein. In some embodiments, the neural network is applied using system 100 of FIG. 1 and/or one or more processing elements 200 of FIG. 2. In some embodiments, the step of 401 is performed at 301 of FIG. 3, the steps of 403, 405, and/or 407 are performed at 303 of FIG. 3, and/or the step of 409 is performed at 305 of FIG. 3. Although the neural network of the example in FIG. 4 includes three layers, additional (or fewer) layers may be utilized as appropriate. Additional intermediate (or hidden) layers of an alternate neural network may function similar to the second layer of the neural network of FIG. 4 as applied at step 405.

At 401, input data is received. For example, input data in the form of a matrix is received. In some embodiments, the matrix is a three-dimensional matrix with dimensions corresponding to height, width, and channels. The input data may be formatted using different data layout formats, for example, depending on how efficient it is to perform a configured matrix operation. In various embodiments, the data layout format utilizes a height×width×channel (HWC) layout, a channel×height×width (CHW) layout, or another appropriate data layout format. The input data may be located in a shared memory or another memory storage medium.

At 403, the first layer of the neural network is applied. For example, the first layer of the neural network is processed using the input data received at 401 as input values. In some embodiments, the first layer is processed by allocating and distributing the neural network operations corresponding to the first layer across one or more different processing elements. Each processing element may be assigned a portion of the neural network operations for the first layer. In some embodiments, the input data is processed using one or more hardware units of the processing elements to convert the input data using an input data layout format compatible with the convolution operation of the first layer. The convolution operation of the first layer is performed by each assigned processing element and once completed, the results may be written back to shared memory before being fed to the second layer of the neural network. In various embodiments, one or more hardware units may be used to convert the results using an output data layout format in preparation for the second layer of the neural network. For example, in some scenarios, the results are scattered to shared memory using an output data layout format compatible with the next layer.

At 405, the second layer of the neural network is applied. For example, the results of the first layer performed at 403 and stored in shared memory are used as input to the second layer of the neural network. In some embodiments, similar to the first layer, the second layer is processed by allocating and distributing the neural network operations corresponding to the second layer across one or more different processing elements. Each processing element may be assigned a portion of the neural network operations for the second layer. In some embodiments, the input data to the second layer is processed using one or more hardware units to convert the input data using an input data layout compatible with the convolution operation of the second layer. The convolution operation of the second layer is performed by each assigned processing element and once completed, the results may be written back to shared memory before being fed to the third layer of the neural network. In various embodiments, one or more hardware units may be used to convert the results using an output data layout format in preparation for the third layer of the neural network.

At 407, the third and final layer of the neural network is applied. For example, the results of the second layer performed at 405 and stored in shared memory are used as input to the third and final layer of the neural network. In some embodiments, similar to the first and second layers, the third layer is processed by allocating and distributing the neural network operations corresponding to the third layer across one or more different processing elements. Each processing element may be assigned a portion of the neural network operations for the third layer. In some embodiments, the input data to the third layer is processed using one or more hardware units to convert the input data using an input data layout compatible with the convolution operation of the third layer. The convolution operation of the third layer is performed by each assigned processing element and once completed, the results may be written back to shared memory. In various embodiments, one or more hardware units may be used to convert the results using an output data layout format of the expected result for the neural network.

At 409, a neural network output result is received. For example, at the completion of 407, each processing element may write its processing results to a shared memory. The partial results are combined to form the complete neural network output result. In some embodiments, the partial output results may be processed before determining the final neural network output result. Upon completion, the output result is the output result of applying the neural network to the input data received at 401. In various embodiments, the output result received is used to solve an artificial intelligence problem.

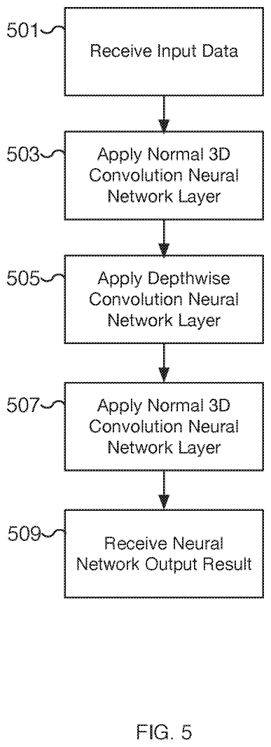

FIG. 5 is a flow chart illustrating an embodiment of a process for solving artificial intelligence problems using a multi-layer neural network. In the example shown, a neural network with three layers is applied to input data to solve complex artificial intelligence problems such as image recognition and recommendation. The convolution operation utilized by each layer differs from the previous layer and results in mismatched input and output data layout formats between convolution operations of different layers. The first layer utilizes a three-dimensional convolution, the second layer utilizes a depthwise convolution, and the third and final layer utilizes a three-dimensional convolution. In various embodiments, other convolution types and combinations may be appropriate. In some embodiments, the neural network applied in the process of FIG. 5 is the three-layer neural network of FIG. 4. In some embodiments, the step of 501 is performed at 401 of FIG. 4, the step of 503 is performed at 403 of FIG. 4, the step of 505 is performed at 405 of FIG. 4, the step of 507 is performed at 407 of FIG. 4, and/or the step of 509 is performed at 409 of FIG. 4. Although the neural network of the example in FIG. 5 includes three layers with specific convolution operations, additional (or fewer) layers and convolution combinations/types may be utilized as appropriate.

In various embodiments, the input data to a neural network layer may not be in the data layout format expected by the convolution operation of that layer. Similarly, the results of the convolution operation may not be saved using the data layout format of the current layer or the subsequent layer. Instead, input and/or output data layout conversions may be performed by the processing elements. Hardware units of each processing element, such as a transpose hardware unit, a scatter hardware unit, and/or a gather hardware unit, may be utilized to convert the input data according to a data layout format expected by the matrix processor unit for performing the convolution operation of each layer. Similarly, hardware units of each processing element may be utilized to convert the convolution result determined by the matrix processor unit according to an output data layout format compatible with and in preparation for the next neural network layer. In some embodiments, the data formats utilized are intermediate data layout formats for efficient processing.

At 501, input data is received. For example, the input data is received from shared memory for processing by one or more processing elements. The input data may be a three-dimensional matrix such as image data with multiple channels. In some embodiments, the input data is received as described with respect to step 401 of FIG. 4.

At 503, a normal three-dimensional convolution neural network layer is applied. The first layer of the neural network utilizes a three-dimensional convolution operation. For example, a kernel is applied to the input received at 501 using a three-dimensional convolution. Partial results of the first layer may be determined by different processing elements, with each assigned processing element applying a three-dimensional convolution using a matrix processor unit with assigned portions of the input data. The results can be merged into shared memory and fed to the second layer of the neural network. In some embodiments, hardware units such as a transpose hardware unit, a scatter hardware unit, and/or a gather hardware unit may be utilized to prepare the input and output data according to input and output data layout formats. In various embodiments, the data fed to the matrix processor unit is converted to a height×weight×channel (HWC) format to take advantage of reduction across channels.

At 505, a depthwise convolutional neural network layer is applied. The second layer of the neural network utilizes a depthwise convolution operation. For example, a kernel is applied to the output of step 503 using a depthwise convolution. Partial results of the second layer may be determined by different processing elements, with each assigned processing element applying a depthwise convolution using a matrix processor unit with assigned portions of the input data. The results can be merged into shared memory and fed to the third layer of the neural network. Because of the format mismatch between layers one and two and between layers two and three, hardware units such as a transpose hardware unit, a scatter hardware unit, and/or a gather hardware unit may be utilized to prepare the input and output data according to input and output data layout formats. In various embodiments, the data has low arithmetic intensity with few opportunities for data reuse across channels. Instead of utilizing a height×weight×channel (HWC) format, the input data for the matrix processor unit is converted to a channel×height×weight (CHW) format for more efficient processing.

At 507, a normal three-dimensional convolution neural network layer is applied. The third and final layer of the neural network utilizes a three-dimensional convolution operation. For example, a kernel is applied to the output of step 505 using a three-dimensional convolution. Partial results of the third and final layer may be determined by different processing elements, with each assigned processing element applying a three-dimensional convolution using a matrix processor unit with assigned portions of the input data. The results can be merged into shared memory to determine the output result of the neural network. Because of the format mismatch between layers two and three, hardware units such as a transpose hardware unit, a scatter hardware unit, and/or a gather hardware unit may be utilized to prepare the input and output data according to input and output data layout formats. In various embodiments, the data fed to the matrix processor unit is converted to a height×weight×channel (HWC) format to take advantage of reduction across channels.

At 509, the neural network output result is received. The final neural network output result is received and may be used for solving a complex artificial intelligence problem. In some embodiments, the neural network output result is received as described with respect to step 409 of FIG. 4.

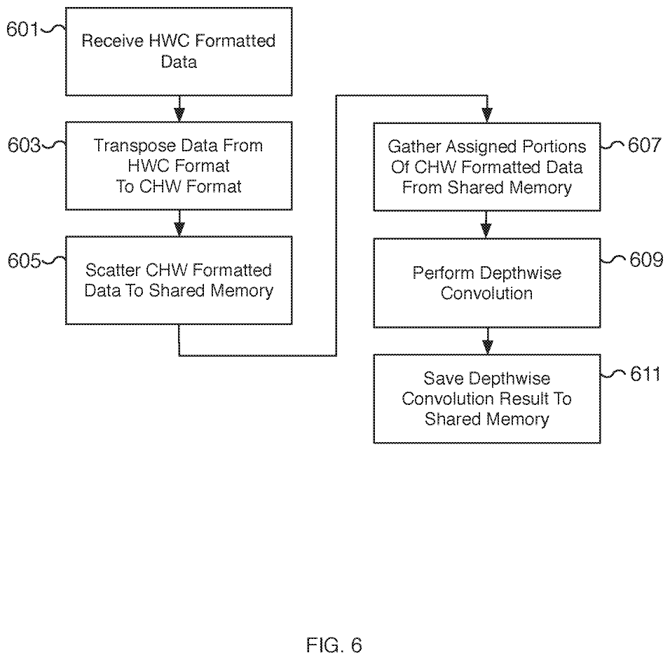

FIG. 6 is a flow chart illustrating an embodiment of a process for solving artificial intelligence problems using a multi-layer neural network. In the example shown, the data layout format is transformed across two different neural network layers, with layer two applying a depthwise convolution. In some embodiments, the first neural network layer utilizes different convolution operations from the second layer. In some embodiments, the steps of 601, 603, and 605 are performed at 403 of FIG. 4 and/or 503 of FIG. 5 and correspond to portions of the first layer of the neural networks of FIGS. 4 and 5. In some embodiments, the steps of 607, 609, and 611 are performed at 405 of FIG. 4 and/or 505 of FIG. 5 and correspond to the second layer of the neural networks of FIGS. 4 and 5. In some embodiments, the process of FIG. 6 is performed using system 100 of FIG. 1 and/or one or more processing elements 200 of FIG. 2.

At 601, height×weight×channel (HWC) formatted data is received. For example, the data may be the result of performing a matrix operation, such as a three-dimensional convolution operation, using HWC formatted input data for a neural network layer. In some embodiments, the HWC data is a dot product engine result. Using an HWC formatted data layout, the inner dimension of the data is channel data.

At 603, height×weight×channel (HWC) formatted data is transposed to a channel×height×weight (CHW) format. For example, a transpose operation converts the data from having channel data as the inner dimension to having channel data as the outer dimension. In some embodiments, a transpose hardware unit or transpose engine, such as transpose unit 207 of FIG. 2, performs a matrix transpose local to each processing element. In various embodiments, block level access to memory is allowed for performing transpose operations.

At 605, channel×height×weight (CHW) formatted data is scattered to shared memory. For example, each processing element saves its respective results to shared memory by scattering the channel data such that all data belonging to a channel is contiguous. In some embodiments, the addresses for the scatter operations implemented across different processing elements are controlled by arguments to a scatter operation primitive. The data transposed at 603 is stored in a CHW format in shared memory and can be accessed by one or more different processing elements for applying the next layer of the neural network. In various embodiments, the scatter operation is performed by each processing element using a scatter hardware unit such as scatter unit 209 of FIG. 2 to shared memory such as memory 101 of FIG. 1.

At 607, assigned portions of channel×height×weight (CHW) formatted data are gathered from shared memory. In some embodiments, the step of 607 is the start of a depthwise convolution layer that begins by obtaining an assigned data workload from shared memory. The data is gathered by each processing element by utilizing a gather hardware unit such as gather unit 211 of FIG. 2. The data of assigned channels is gathered into each respective processing element. In some embodiments, each processing element is assigned a single channel.

At 609, a depthwise convolution is performed. For example, a convolution operation is performed using the data gathered into a processing element at 607 and a convolution filter. In some embodiments, the convolution operation is performed by each processing element using a matrix processor unit such as matrix processor unit 203 of FIG. 2. The results for each processing element correspond to the results for the assigned channel(s).

At 611, the result of depthwise convolution is saved to shared memory. For example, the convolution result of each processing element is saved to a shared memory such as memory 101 of FIG. 1. In various embodiments, the results for each processing element correspond to a single channel and the channel data can be written as a contiguous write by each processing element. The resulting data is stored in shared memory as channel×height×weight (CHW) formatted data with all data belonging to a channel stored contiguously. In some embodiments, the addresses for the saving of data to shared memory are controlled by arguments to a write operation primitive. In some embodiments, the write operation utilizes the scatter operation.

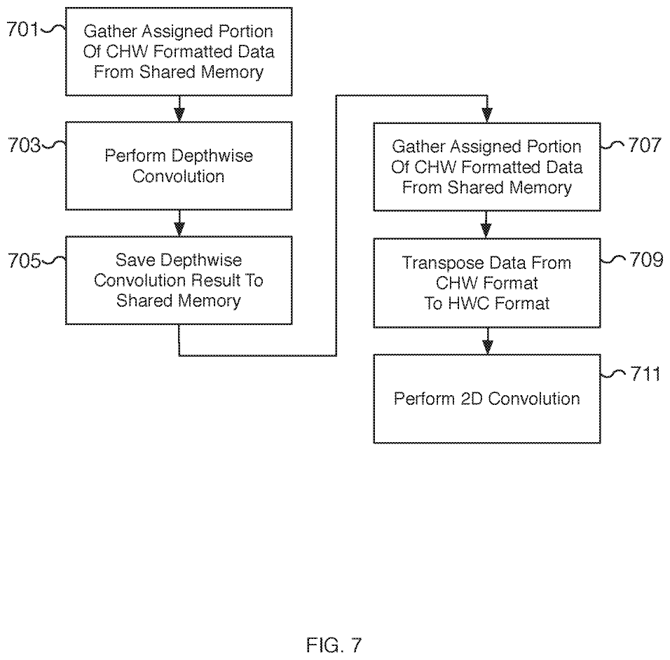

FIG. 7 is a flow chart illustrating an embodiment of a process for solving artificial intelligence problems using a multi-layer neural network. In the example shown, the data layout format is transformed across two different neural network layers, with the first layer applying a depthwise convolution and the second layer applying a normal three-dimensional convolution. The different neural network layers require changing the data layout of the input. In some embodiments, the steps of 701, 703, and 705 are performed at 405 of FIG. 4 and/or 505 of FIG. 5 and correspond to the second layer of the neural networks of FIGS. 4 and 5. In some embodiments, the steps of 701, 703, and 705 are steps 607, 609, and 611 of FIG. 6, respectively. In some embodiments, the steps of 707, 709, and 711 are performed at 407 of FIG. 4 and/or 507 of FIG. 5 and correspond to portions of the third layer of the neural networks of FIGS. 4 and 5. In some embodiments, the process of FIG. 7 is performed using system 100 of FIG. 1 and/or one or more processing elements 200 of FIG. 2.

At 701, assigned portions of channel×height×weight (CHW) formatted data are gathered from shared memory. In some embodiments, the step of 701 is the start of a depthwise convolution layer that begins by obtaining an assigned data workload from shared memory. The data is gathered by each processing element by utilizing a gather hardware unit such as gather unit 211 of FIG. 2. The data of assigned channels is gathered into each respective processing element. In some embodiments, each processing element is assigned a single channel.

At 703, a depthwise convolution is performed. For example, a convolution operation is performed using the data gathered into a processing element at 701 and a convolution filter. In some embodiments, the convolution operation is performed by each processing element using a matrix processor unit such as matrix processor unit 203 of FIG. 2. The results for each processing element correspond to the results for the assigned channel(s).

At 705, the result of depthwise convolution is saved to shared memory. For example, the convolution result of each processing element is saved to a shared memory such as memory 101 of FIG. 1. In various embodiments, the results for each processing element correspond to a single channel and the channel data can be written as a contiguous write by each processing element. The resulting data is stored in shared memory as channel×height×weight (CHW) formatted data with all data belonging to a channel stored contiguously. In some embodiments, the addresses for the saving of data to shared memory are controlled by arguments to a write operation primitive. In some embodiments, the write operation utilizes the scatter operation.

At 707, assigned portions of channel×height×weight (CHW) formatted data are gathered from shared memory. In some embodiments, the step of 707 is the start of a two dimensional convolution layer that begins by obtaining an assigned data workload from shared memory. The data is gathered by each processing element by utilizing a gather hardware unit such as gather unit 211 of FIG. 2. In contrast to the gather operation of step 701, at 707, the gather operation reads data from each channel. In some embodiments, the read operation is a stride read and each processing element obtains data from different channels. In some embodiments, the memory locations from which to gather the data are specified by arguments to a gather operation primitive.

At 709, channel×height×weight (CHW) formatted data is transposed to a height×weight×channel (HWC) format. For example, a transpose operation converts the data from having channel data as the outer dimension to having channel data as the inner dimension. In some embodiments, a transpose hardware unit or transpose engine, such as transpose unit 207 of FIG. 2, performs a matrix transpose local to each processing element.

At 711, a normal three-dimensional convolution is performed. For example, a convolution operation is performed using the transposed data gathered into a processing element and a convolution filter. In some embodiments, the convolution operation is performed by each processing element using a matrix processor unit such as matrix processor unit 203 of FIG. 2. The results for each processing element correspond to the results for the assigned workload. In some embodiments, the results are saved to shared memory, transposed, and/or scattered to shared memory.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A microprocessor, comprising:
a shared memory; and
a processing element including:
a matrix processor unit configured to perform a matrix operation;
a transpose hardware unit configured to perform a matrix transpose operation;
a scatter hardware unit configured to place data to the shared memory at locations selected for an output data layout conversion; and
a gather hardware unit configured to obtain input data from the shared memory from non-contiguous locations for an input data layout conversion.

2. The microprocessor of claim 1, wherein the transpose hardware unit, the scatter hardware unit, and the gather hardware unit are different units configured to be operated at least in part in parallel.

3. The microprocessor of claim 2, wherein operations of the transpose hardware unit, the scatter hardware unit, and the gather hardware unit are configured to be scheduled to execute in parallel.

4. The microprocessor of claim 2, wherein the transpose hardware unit, the scatter hardware unit, and the gather hardware unit are configured for pipelined operation.

5. The microprocessor of claim 1, wherein the data placed by the scatter hardware unit includes at least a portion of a result data of the matrix processor unit.

6. The microprocessor of claim 1, wherein the matrix processor unit is configured to process the input data obtained by the gather hardware unit.

7. The microprocessor of claim 1, wherein performing the output data layout conversion includes converting an output data layout format of a first neural network layer to a different input data layout format of a second neural network layer.

8. The microprocessor of claim 1, wherein performing the output data layout conversion includes converting a first data layout format associated with a matrix processor result of a first neural network layer to a second data layout format associated with a second neural network layer, wherein the first and second data layout formats are different.

9. The microprocessor of claim 8, wherein an inner dimension of the first data layout format corresponds to one of the outer dimensions of the second data layout format.

10. The microprocessor of claim 1, wherein performing the input data layout conversion includes converting an output data layout format of a first neural network layer to a different input data layout format of a second neural network layer.

11. The microprocessor of claim 1, wherein performing the input data layout conversion includes converting a first data layout format associated with a first neural network layer to a second data layout format associated with a second neural network layer, wherein the first and second data layout formats are different, and wherein the first data layout format is an output data layout format and the second data layout format is an input data layout format.

12. The microprocessor of claim 1, wherein the matrix processor unit is a dot product engine.

13. The microprocessor of claim 1, wherein the transpose hardware unit, the scatter hardware unit, and the gather hardware unit are each configured to operate at a throughput that at least meets a maximum throughput of the matrix processor unit.

14. The microprocessor of claim 1, wherein the gather hardware unit is configured to obtain the input data from the shared memory including by being configured to perform cache-line block reads.

15. The microprocessor of claim 1, wherein the matrix operation is a depthwise convolution or a three-dimensional convolution.

16. The microprocessor of claim 1, wherein the locations selected for the output data layout conversion are specified using arguments to a scatter operation primitive.

17. The microprocessor of claim 1, wherein the non-contiguous locations for the input data layout conversion are specified using arguments to a gather operation primitive.

18. The microprocessor of claim 1, wherein the processing element further includes a scheduler unit configured to schedule overlapping operations to the matrix processor unit, the transpose hardware unit, the scatter hardware unit, and the gather hardware unit.

19. A method, comprising:
receiving a local matrix multiplication operation result formatted using a first data layout format;
applying a transpose operation to transpose the local matrix multiplication operation result into a transposed result;
scattering the transposed result into a shared memory using a second data layout format;
gathering an input data matrix from the shared memory to finalize the distributed transpose;
performing a matrix operation on the input data matrix to generate a matrix operation result; and
writing the matrix operation result to the shared memory.

20. A microprocessor, comprising:
a shared memory; and
a plurality of processing elements configured to operate in parallel wherein each processing element includes:
a matrix processor unit configured to perform a matrix operation;
a transpose hardware unit configured to perform a matrix transpose operation;
a scatter hardware unit configured to place data to a shared memory at locations selected for an output data layout conversion; and
a gather hardware unit configured to obtain input data from the shared memory from non-contiguous locations for an input data layout conversion.
